(19) United States
(12) Patent Application Publication
(10) Pub. No.: US 2025/0207008 A1
(43) Pub. Date: Jun. 26, 2025

(54) SLOW-RELEASE SALT-STORAGE SNOW-MELTING AND ICE-SUPPRESSING MICROCAPSULE

(71) Applicant: Gansu Suoying Technology Co., Ltd, Dingxi (CN)

(72) Inventor: Jinghua WANG, Dingxi (CN)

(21) Appl. No.: 18/642,655

(22) Filed: Apr. 22, 2024

(30) Foreign Application Priority Data
Dec. 21, 2023 (CN) 202311772422.6

(51) Int. Cl. C09K 3/18; B01J 13/12

(52) U.S. Cl. CPC C09K 3/185; B01J 13/12

(57) ABSTRACT

Disclosed are a slow-release salt-storage snow-melting and ice-suppressing microcapsule and a preparation method thereof, falling within the technical field of highway engineering in traffic and transportation engineering. In the present disclosure, a slow-release salt-storage snow-melting and ice-suppressing microcapsule is prepared using a high polymer material as a wall material and salt as a core material by a spray drying method, a phase separation method or an interfacial polymerization method. According to the present disclosure, the salt is encapsulated in the high polymer wall material, and as the wall material has good water-blocking ability, it can control the release of salt, thus significantly slowing down a rate of salt release, improving a utilization rate in snow-melting and deicing, and effectively solving the problem of freezing of accumulated snow on pavements in winter.

### CROSS-REFERENCE TO RELATED APPLICATIONS

This application claims priority of Chinese Patent Application No. 202311772422.6, filed on Dec. 21, 2023, the entire contents of which are incorporated herein by reference.

### TECHNICAL FIELD

The present disclosure relates to the technical field of highway engineering in traffic and transportation engineering, and more specifically to a slow-release salt-storage snow-melting and ice-suppressing microcapsule and a preparation method thereof.

### BACKGROUND

Most areas in northern China are plagued by snow and ice disasters on road in winter. Studies have shown that a road adhesion coefficient is 0.6 in dry conditions, compared to only 0.2 in snowy conditions and 0.15 in icy conditions. A reduced adhesion coefficient results in a longer braking distance of vehicles, increasing the traffic accident rate in winter, affecting the safety of people's lives, seriously affecting traffic, and causing enormous economic losses.

In order to ensure a smooth pavement and driving safety, avoid or reduce traffic accidents, and improve the pavement rideability and operating efficiency, it is necessary to take snow-melting and ice-suppressing technical measures to remove ice and snow from the pavement, thus alleviating the problems mentioned above. A salt-storage asphalt pavement, applying an active snow-melting and ice-suppressing technology by releasing salt to melt snow and ice on the pavement, is constructed by replacing part of mineral aggregate in a mixture with anti-freezing agents in the process of mixing asphalt mixture. Comprehensively influenced by a low temperature, precipitation (rainfall, snowfall, freezing, freezing rain, etc.) and the presence of voids in a pavement structure, the anti-freezing agent in the mixture migrates from the interior of the pavement to the surface through the voids in the mixture under the combined action of pump suction caused by wheel rolling, capillary pressure and salt solution concentration gradient, in order to reduce a freezing point of aqueous solution on the pavement to melt snow and suppress ice. However, in the salt-storage asphalt pavement, salt and asphalt mixture are mixed directly for use, which will be washed by water during use, making the salt in the salt-storage asphalt pavement easy to lose, so that the durability of snow-melting and ice-suppressing cannot be guaranteed.

### SUMMARY

In response to the above problems, the present disclosure provides a slow-release salt-storage snow-melting and ice-suppressing microcapsule and a preparation method thereof. In the present disclosure, a high polymer material, used as a wall material, encapsulates salt, and as the wall material has good water-blocking ability, it can control the release of salt, thus significantly slowing down a rate of salt release, improving a utilization rate in snow-melting and deicing, and effectively solving the problem of freezing of accumulated snow on pavements in winter.

A first objective of the present disclosure is to provide a slow-release salt-storage snow-melting and ice-suppressing microcapsule. The slow-release salt-storage snow-melting and ice-suppressing microcapsule is prepared using a high polymer material as a wall material and salt as a core material.

In an embodiment of the present disclosure, the salt is one of potassium acetate, sodium chloride, calcium chloride, magnesium chloride and potassium chloride; and
the high polymer material is one of gum arabic, gelatin, polyvinyl alcohol, agar, amylose, polylactic acid, fibrous protein, polylactic acid-polyhydroxyacetic acid, and polycarbonate.

A second objective of the present disclosure is to provide a preparation method for the slow-release salt-storage snow-melting and ice-suppressing microcapsule mentioned above, including the following steps of:
dissolving salt in water, and encapsulating the salt with a wall material to obtain a slow-release salt-storage snow-melting and ice-suppressing microcapsule using a spray drying method, a phase separation method or an interfacial polymerization method.

In an embodiment of the present disclosure, a slow-release salt-storage snow-melting and ice-suppressing microcapsule is prepared using the spray drying method, including the following steps of:
dissolving salt in water to obtain a solution A; dissolving a wall material in water, followed by heating and stirring at 90-97° C. to obtain a solution B; and performing homogeneous dispersion of the solution B and the solution A before performing uniform mixing, performing dilution until a solid content is 10%-20% to obtain a solution C, and performing spray-drying of the solution C to obtain the slow-release salt-storage snow-melting and ice-suppressing microcapsule.

In an embodiment of the present disclosure, the wall material accounts for 5%-40% of a total mass of the salt and the wall material, a rotating speed of the homogeneous dispersion is 8000-12000 rpm, and a time of the homogeneous dispersion is 5-15 min;
the wall material is one of gum arabic, gelatin, polyvinyl alcohol, agar, and amylose; and
conditions of the spray-drying are: an inlet temperature of 180-220° C., an outlet temperature of 80-115° C., an inlet air volume of 75-90 m3/h, a feed rate of 10-20 mL/min, and a pressure pump of 0.15-0.3 MPa.

In an embodiment of the present disclosure, a slow-release salt-storage snow-melting and ice-suppressing microcapsule is prepared using the phase separation method, including the following steps of:
dissolving salt in water, followed by stirring uniformly to obtain a solution A; and dissolving a wall material in an organic solvent A, followed by stirring to obtain a solution B; and
mixing the solution B and the solution A before performing uniform homogeneous dispersion to obtain a solution D, adding the solution D to an organic solvent B, followed by stirring to obtain a microcapsule-containing multiple emulsion; and stirring the microcapsule-containing multiple emulsion before performing curing to obtain the slow-release salt-storage snow-melting and ice-suppressing microcapsule.

In an embodiment of the present disclosure, a mass ratio of the salt to the water is 1:3-19; the wall material accounts for 5%-40% of a total mass of the salt and the wall material; and a mass ratio of the wall material to the organic solvent A is 1:1-99;
a rotating speed of the homogeneous dispersion is 1000-8000 rpm, and a time of the homogeneous dispersion is 5-30 min;
a mass ratio of the organic solvent B to the solution D is 1:1-2.5;
the wall material is one of polylactic acid, gelatin, fibrous protein, polyvinyl alcohol, polylactic acid-polyhydroxyacetic acid, and polycarbonate;
the organic solvent A is one of dichloromethane, ethyl acetate, acetonitrile, heptane, chloroform or acetone; and
the organic solvent B is one of glycerol, ethanol, propylene glycol, ethylene glycol or dimeticone.

In an embodiment of the present disclosure, a slow-release salt-storage snow-melting and ice-suppressing microcapsule is prepared using the interfacial polymerization method, including the following steps of:
dissolving salt and a monomer A in water, followed by stirring uniformly to obtain a solution A, and adjusting a pH value of the solution A to 10-11 to obtain an aqueous phase solution;
adding an emulsifier to an organic solvent C to obtain an oil phase solution;
performing uniform homogeneous dispersion of the aqueous phase solution and the oil phase solution to obtain an emulsion; and
dissolving a monomer D in an organic solvent D to obtain a solution E, adding the solution E to the emulsion, followed by stirring uniformly and reacting to obtain a final solution F, and filtering, washing and drying the solution F in sequence to obtain the slow-release salt-storage snow-melting and ice-suppressing microcapsule.

In an embodiment of the present disclosure, a mass ratio of the salt to the water is 1:3-19;
a ratio of the emulsifier to the organic solvent C is 1-3 g:100 ml, the emulsifier being one of sodium dodecylbenzene sulfonate, sodium alginate, sorbitol, styrene-maleic anhydride, span 20, span 40, span 60, span 80, tween 20, tween 40, tween 60, and tween 80;
a volume ratio of the organic solvent C and the organic solvent D to the water is 2-5:1, and a volume ratio of the organic solvent C to the organic solvent D is 1-3:1, both the organic solvent C and the organic solvent D being one of cyclohexane, dichloromethane, carbon tetrachloride, toluene, and chloroform;
a sum of the monomer A and the monomer D accounts for 5%-40% of a total mass of the salt, the monomer A and the monomer D, and a molar ratio of the monomer A to the monomer D is 1:1, the monomer A being one of ethylenediamine, ethylene glycol, and ethylenediphenol, and the monomer D being one of terephthaloyl chloride, toluene diisocyanate, and adipoyl chloride; and
a rotating speed of the homogeneous dispersion is 1000-8000 rpm, and a time of the homogeneous dispersion is 5-30 min.

In an embodiment of the present disclosure, a pH modifier is employed to adjust the pH value, the pH modifier being one of sodium hydroxide, potassium hydroxide, sodium bicarbonate, sodium carbonate, potassium carbonate.

Compared with the prior art, the present disclosure has the following beneficial effects.

(1) In the present disclosure, the high polymer material is employed as the wall material, in which salt is encapsulated to make a snow-melting and deicing material, which is longer in time for salt slow release, stronger in ability to lower the freezing point, and more long-lasting than anti-freezing agents prepared by a wet adsorption method as well as anti-freezing agents commercially available.

(2) The wall material of the snow-melting and ice-suppressing material prepared in the present disclosure is made from a high polymer material, which has good stability and corrosion resistance.

(3) The preparation method of the present disclosure is simple and controllable, and is inexpensive in the raw materials for production, which is suitable for industrialized mass production of snow-melting and ice-suppressing microcapsule materials.

### BRIEF DESCRIPTION OF THE DRAWINGS

FIG. 1 shows conductivity changes for complete dissolution of materials prepared in Examples 1-4; and

FIG. 2 shows conductivity changes for complete dissolution of materials prepared in Example 3, Example 14, Example 26, Comparative Example 1, and of a Mafilon material.

### DETAILED DESCRIPTION

The technical solutions of the examples in the present disclosure will be described clearly and completely by reference to the accompanying drawings of the examples in the present disclosure below. Obviously, the examples described are only some, rather than all examples of the present disclosure. On the basis of the examples of the present disclosure, all other examples obtained by those ordinary skilled in the art without creative efforts fall within the scope of protection of the present disclosure.

In a salt-storage asphalt pavement, salt and asphalt mixture are mixed directly for use, which will be washed by water during use, making the salt in the salt-storage asphalt pavement easy to lose, so that the durability of snow-melting and ice-suppressing cannot be guaranteed. On the basis of this, in the present disclosure, salt is encapsulated in a high polymer wall material, and as the wall material has good water-blocking ability, it can control the release of salt, thus significantly slowing down a rate of salt release, improving a utilization rate in snow-melting and deicing, and effectively solving the problem of freezing of accumulated snow on pavements in winter.

Microcapsule encapsulation technology refers to the method of encapsulating a target (core material) in a dense membrane (wall material) to form a microcapsule. The wall material is typically made from natural or synthetic high polymer materials. Microcapsule membranes have the effect of changing the appearance and properties of a substance, as well as prolonging and controlling the release of the substance within the membrane and improving the storage stability of the substance. Microcapsules are categorized into impermeable microcapsules and semi-permeable microcapsules depending on capsule materials. The semi-permeable microcapsules are used without destroying the wall material and the core material, and small molecule substances in the environment are able to freely pass through the wall material and eventually reach equilibrium, thus achieving the function of slow release and controlled release. In the present disclosure, a slow-release salt-storage snow-melting and ice-suppressing microcapsule is prepared using three methods, namely, a spray drying method, a phase separation method and an interfacial polymerization method.

The spray drying method is implemented as follows. A core material and a wall material are mixed uniformly to form a spray working solution, which is diluted with water to a certain concentration before being dispersed into small uniform droplets by a rotary centrifugal effect of an atomizer, and the droplets are dried by means of hot air or other gases, so that the droplets formed by the wall material wrapping the core material will be quickly cured to form microcapsule powder.

The interfacial polymerization method is implemented as follows. Condensation polymerization is performed on two substances having different active groups, namely, oil-soluble monomers such as isocyanate and water-soluble monomers such as polyols, at an interface through a chain extender to form polyurea, polyamide, polyurethane and other polymer films (i.e., wall materials) with a certain degree of hardness on the surface of core material droplets, thereby encapsulating the target, i.e. a core material.

The phase separation method is implemented as follows. A core material is dissolved in water, followed by stirring and dispersing in a wall material of an organic solvent, thus forming a water-in-oil (W/O) inner emulsion. The inner emulsion is added to an aqueous solution containing an emulsifier to form a water-in-oil-in-water (W/O/W) multi-phase emulsion, and then a reagent that only extracts organic solvents is added, followed by stirring. The solubility of the wall material is reduced and the wall material precipitates, thus encapsulating the core material, and a microcapsule is prepared.

### Example 1

The example provides a preparation method for a slow-release salt-storage snow-melting and ice-suppressing microcapsule, including the following steps.

At step (1), 9.5 g of sodium chloride was dissolved in 50 g of deionized water, followed by thoroughly stirring for dissolving to obtain a solution A.

At step (2), 0.5 g of gelatin was dissolved in 10 g of deionized water, followed by thoroughly stirring at 92° C. for dissolving before cooling to room temperature to obtain a solution B.

At step (3), the solution A was added to the solution B, followed by diluting with water until a solid content was 15%, and homogenization was performed at 10000 rpm for 10 min to obtain a solution C.

At step (4), the solution C obtained in step (3) was subject to spray-drying, with an inlet temperature of 210° C., an outlet temperature of 115° C., an inlet air volume of 85 m3/h, a feed rate of 15 mL/min, and a pressure pump of 0.2 MPa, to obtain a slow-release salt-storage snow-melting and ice-suppressing microcapsule.

### Example 2

The example provides a preparation method for a slow-release salt-storage snow-melting and ice-suppressing microcapsule, including the following steps.

At step (1), 9 g of sodium chloride was dissolved in 50 g of deionized water, followed by thoroughly stirring for dissolving to obtain a solution A.

At step (2), 1 g of gelatin was dissolved in 10 g of deionized water, followed by thoroughly stirring at 92° C. for dissolving before cooling to room temperature to obtain a solution B.

At step (3), the solution A was added to the solution B, followed by diluting with water until a solid content was 15%, and homogenization was performed at 10000 rpm for 10 min to obtain a solution C.

At step (4), the solution C obtained in step (3) was subject to spray-drying, with an inlet temperature of 210° C., an outlet temperature of 115° C., an inlet air volume of 85 m3/h, a feed rate of 15 mL/min, and a pressure pump of 0.2 MPa, to obtain a slow-release salt-storage snow-melting and ice-suppressing microcapsule.

### Example 3

The example provides a preparation method for a slow-release salt-storage snow-melting and ice-suppressing microcapsule, including the following steps.

At step (1), 8 g of sodium chloride was dissolved in 50 g of deionized water, followed by thoroughly stirring for dissolving to obtain a solution A.

At step (2), 2 g of gelatin was dissolved in 10 g of deionized water, followed by thoroughly stirring at 92° C. for dissolving before cooling to room temperature to obtain a solution B.

At step (3), the solution A was added to the solution B, followed by diluting with water until a solid content was 15%, and homogenization was performed at 10000 rpm for 10 min to obtain a solution C.

At step (4), the solution C obtained in step (3) was subject to spray-drying, with an inlet temperature of 215° C., an outlet temperature of 115° C., an inlet air volume of 85 m3/h, a feed rate of 15 mL/min, and a pressure pump of 0.2 MPa, to obtain a slow-release salt-storage snow-melting and ice-suppressing microcapsule.

### Example 4

At step (1), 6 g of sodium chloride was dissolved in 50 g of deionized water, followed by thoroughly stirring for dissolving to obtain a solution A.

At step (2), 4 g of gelatin was dissolved in 10 g of deionized water, followed by thoroughly stirring at 92° C. for dissolving before cooling to room temperature to obtain a solution B.

At step (3), the solution A was added to the solution B, followed by diluting with water until a solid content was 15%, and homogenization was performed at 10000 rpm for 10 min to obtain a solution C.

At step (4), the solution C obtained in step (3) was subject to spray-drying, with an inlet temperature of 215° C., an outlet temperature of 115° C., an inlet air volume of 85 m3/h, a feed rate of 15 mL/min, and a pressure pump of 0.2 MPa, to obtain a slow-release salt-storage snow-melting and ice-suppressing microcapsule.

### Example 5

The example provides a preparation method for a slow-release salt-storage snow-melting and ice-suppressing microcapsule, including the following steps.

At step (1), 8 g of sodium chloride was dissolved in 50 g of deionized water, followed by thoroughly stirring for dissolving to obtain a solution A.

At step (2), 2 g of agar was dissolved in 10 g of deionized water, followed by thoroughly stirring at 92° C. for dissolving before cooling to room temperature to obtain a solution B.

At step (3), the solution A was added to the solution B, followed by diluting with water until a solid content was 15%, and homogenization was performed at 10000 rpm for 10 min to obtain a solution C.

At step (4), the solution C obtained in step (3) was subject to spray-drying, with an inlet temperature of 215° C., an outlet temperature of 115° C., an inlet air volume of 85 m3/h, a feed rate of 15 mL/min, and a pressure pump of 0.2 MPa, to obtain a slow-release salt-storage snow-melting and ice-suppressing microcapsule.

### Example 6

The example provides a preparation method for a slow-release salt-storage snow-melting and ice-suppressing microcapsule, including the following steps.

At step (1), 8 g of sodium chloride was dissolved in 50 g of deionized water, followed by thoroughly stirring for dissolving to obtain a solution A.

At step (2), 2 g of amylose was dissolved in 10 g of deionized water, followed by thoroughly stirring at 92° C. for dissolving before cooling to room temperature to obtain a solution B.

At step (3), the solution A was added to the solution B, followed by diluting with water until a solid content was 15%, and homogenization was performed at 10000 rpm for 10 min to obtain a solution C.

At step (4), the solution C obtained in step (3) was subject to spray-drying, with an inlet temperature of 215° C., an outlet temperature of 115° C., an inlet air volume of 85 m3/h, a feed rate of 15 mL/min, and a pressure pump of 0.2 MPa, to obtain a slow-release salt-storage snow-melting and ice-suppressing microcapsule.

### Example 7

The example provides a preparation method for a slow-release salt-storage snow-melting and ice-suppressing microcapsule, including the following steps.

At step (1), 8 g of sodium chloride was dissolved in 50 g of deionized water, followed by thoroughly stirring for dissolving to obtain a solution A.

At step (2), 2 g of polyvinyl alcohol was dissolved in 10 g of deionized water, followed by thoroughly stirring at 92° C. for dissolving before cooling to room temperature to obtain a solution B.

At step (3), the solution A was added to the solution B, followed by diluting with water until a solid content was 15%, and homogenization was performed at 10000 rpm for 10 min to obtain a solution C.

At step (4), the solution C obtained in step (3) was subject to spray-drying, with an inlet temperature of 215° C., an outlet temperature of 115° C., an inlet air volume of 85 m3/h, a feed rate of 15 mL/min, and a pressure pump of 0.2 MPa, to obtain a slow-release salt-storage snow-melting and ice-suppressing microcapsule.

### Example 8

The example provides a preparation method for a slow-release salt-storage snow-melting and ice-suppressing microcapsule, including the following steps.

At step (1), 9.5 g of calcium chloride was dissolved in 50 g of deionized water, followed by thoroughly stirring for dissolving to obtain a solution A.

At step (2), 0.5 g of gum arabic was dissolved in 10 g of deionized water, followed by thoroughly stirring at 92° C. for dissolving before cooling to room temperature to obtain a solution B.

At step (3), the solution A was added to the solution B, followed by diluting with water until a solid content was 15%, and homogenization was performed at 8000 rpm for 5 min to obtain a solution C.

At step (4), the solution C obtained in step (3) was subject to spray-drying, with an inlet temperature of 180° C., an outlet temperature of 80° C., an inlet air volume of 75 m3/h, a feed rate of 10 mL/min, and a pressure pump of 0.15 MPa, to obtain a slow-release salt-storage snow-melting and ice-suppressing microcapsule.

### Example 9

The example provides a preparation method for a slow-release salt-storage snow-melting and ice-suppressing microcapsule, including the following steps.

At step (1), 9.5 g of potassium acetate was dissolved in 50 g of deionized water, followed by thoroughly stirring for dissolving to obtain a solution A.

At step (2), 0.5 g of agar was dissolved in 10 g of deionized water, followed by thoroughly stirring at 92° C. for dissolving before cooling to room temperature to obtain a solution B.

At step (3), the solution A was added to the solution B, followed by diluting with water until a solid content was 15%, and homogenization was performed at 12000 rpm for 15 min to obtain a solution C.

At step (4), the solution C obtained in step (3) was subject to spray-drying, with an inlet temperature of 220° C., an outlet temperature of 100° C., an inlet air volume of 90 m3/h, a feed rate of 20 mL/min, and a pressure pump of 0.3 MPa, to obtain a slow-release salt-storage snow-melting and ice-suppressing microcapsule.

### Example 10

The example provides a preparation method for a slow-release salt-storage snow-melting and ice-suppressing microcapsule, including the following steps.

At step (1), 9.5 g of magnesium chloride was dissolved in 50 g of deionized water, followed by thoroughly stirring for dissolving to obtain a solution A.

At step (2), 0.5 g of polyvinyl alcohol was dissolved in 10 g of deionized water, followed by thoroughly stirring at 92° C. for dissolving before cooling to room temperature to obtain a solution B.

At step (3), the solution A was added to the solution B, followed by diluting with water until a solid content was 10%, and homogenization was performed at 8000 rpm for 10 min to obtain a solution C.

At step (4), the solution C obtained in step (3) was subject to spray-drying, with an inlet temperature of 210° C., an outlet temperature of 115° C., an inlet air volume of 85 m3/h, a feed rate of 15 mL/min, and a pressure pump of 0.2 MPa, to obtain a slow-release salt-storage snow-melting and ice-suppressing microcapsule.

### Example 11

The example provides a preparation method for a slow-release salt-storage snow-melting and ice-suppressing microcapsule, including the following steps.

At step (1), 9.5 g of potassium chloride was dissolved in 50 g of deionized water, followed by thoroughly stirring for dissolving to obtain a solution A.

At step (2), 0.5 g of amylose was dissolved in 10 g of deionized water, followed by thoroughly stirring at 97° C. for dissolving before cooling to room temperature to obtain a solution B.

At step (3), the solution A was added to the solution B, followed by diluting with water until a solid content was 20%, and homogenization was performed at 10000 rpm for 10 min to obtain a solution C.

At step (4), the solution C obtained in step (3) was subject to spray-drying, with an inlet temperature of 210° C., an outlet temperature of 115° C., an inlet air volume of 85 m3/h, a feed rate of 15 mL/min, and a pressure pump of 0.2 MPa, to obtain a slow-release salt-storage snow-melting and ice-suppressing microcapsule.

### Example 12

At step (1), 9.5 g of sodium chloride was dissolved in 100 g of deionized water to obtain a saline solution.

At step (2), 0.5 g of polylactic acid was added to 40 g of dichloromethane to obtain an oil phase I.

At step (3), the saline solution was added to the oil phase I, followed by homogenizing and shearing at 5000 rpm for 10 min to form a uniform W/O emulsion.

At step (4), the emulsion obtained in step (3) was added to 60 g of propylene glycol, followed by stirring to form a microcapsule-containing multiple emulsion.

At step (5), the microcapsule-containing multiple emulsion obtained in step (4) was subject to magnetic stirring at 200 rmp for 1 h, followed by curing to obtain a final microcapsule.

### Example 13

At step (1), 9 g of sodium chloride was dissolved in 100 g of deionized water to obtain a saline solution.

At step (2), 1 g of polylactic acid was added to 40 g of dichloromethane to obtain an oil phase I.

At step (3), the saline solution was added to the oil phase I, followed by homogenizing and shearing at 5000 rpm for 10 min to form a uniform W/O emulsion.

At step (4), the emulsion obtained in step (3) was added to 60 g of propylene glycol, followed by stirring to form a microcapsule-containing multiple emulsion.

At step (5), the microcapsule-containing multiple emulsion obtained in step (4) was subject to magnetic stirring at 200 rmp for 1 h, followed by curing to obtain a final microcapsule.

### Example 14

At step (1), 8 g of sodium chloride was dissolved in 100 g of deionized water to obtain a saline solution.

At step (2), 2 g of polylactic acid was added to 40 g of dichloromethane to obtain an oil phase I.

At step (3), the saline solution was added to the oil phase I, followed by homogenizing and shearing at 5000 rpm for 10 min to form a uniform W/O emulsion.

At step (4), the emulsion obtained in step (3) was added to 60 g of propylene glycol, followed by stirring to form a microcapsule-containing multiple emulsion.

At step (5), the microcapsule-containing multiple emulsion obtained in step (4) was subject to magnetic stirring at 200 rmp for 1 h, followed by curing to obtain a final microcapsule.

### Example 15

At step (1), 6 g of sodium chloride was dissolved in 100 g of deionized water to obtain a saline solution.

At step (2), 4 g of polylactic acid was added to 40 g of dichloromethane to obtain an oil phase I.

At step (3), the saline solution was added to the oil phase I, followed by homogenizing and shearing at 5000 rpm for 10 min to form a uniform W/O emulsion.

At step (4), the emulsion obtained in step (3) was added to 60 g of propylene glycol, followed by stirring to form a microcapsule-containing multiple emulsion.

At step (5), the microcapsule-containing multiple emulsion obtained in step (4) was subject to magnetic stirring at 200 rmp for 1 h, followed by curing to obtain a final microcapsule.

### Example 16

At step (1), 8 g of sodium chloride was dissolved in 100 g of deionized water to obtain a saline solution.

At step (2), 2 g of gelatin was added to 40 g of dichloromethane to obtain an oil phase I.

At step (3), the saline solution was added to the oil phase I, followed by homogenizing and shearing at 5000 rpm for 10 min to form a uniform W/O emulsion.

At step (4), the emulsion obtained in step (3) was added to 60 g of propylene glycol, followed by stirring to form a microcapsule-containing multiple emulsion.

At step (5), the microcapsule-containing multiple emulsion obtained in step (4) was subject to magnetic stirring at 200 rmp for 1 h, followed by curing to obtain a final microcapsule.

### Example 17

At step (1), 8 g of sodium chloride was dissolved in 100 g of deionized water to obtain a saline solution.

At step (2), 2 g of polyvinyl alcohol was added to 40 g of dichloromethane to obtain an oil phase I.

At step (3), the saline solution was added to the oil phase I, followed by homogenizing and shearing at 5000 rpm for 10 min to form a uniform W/O emulsion.

At step (4), the emulsion obtained in step (3) was added to 60 g of propylene glycol, followed by stirring to form a microcapsule-containing multiple emulsion.

At step (5), the microcapsule-containing multiple emulsion obtained in step (4) was subject to magnetic stirring at 200 rmp for 1 h, followed by curing to obtain a final microcapsule.

### Example 18

At step (1), 8 g of sodium chloride was dissolved in 100 g of deionized water to obtain a saline solution.

At step (2), 2 g of fibrous protein was added to 40 g of dichloromethane to obtain an oil phase I.

At step (3), the saline solution was added to the oil phase I, followed by homogenizing and shearing at 5000 rpm for 10 min to form a uniform W/O emulsion.

At step (4), the emulsion obtained in step (3) was added to 60 g of propylene glycol, followed by stirring to form a microcapsule-containing multiple emulsion.

At step (5), the microcapsule-containing multiple emulsion obtained in step (4) was subject to magnetic stirring at 200 rmp for 1 h, followed by curing to obtain a final microcapsule.

### Example 19

At step (1), 6 g of calcium chloride was dissolved in 27 g of deionized water to obtain a saline solution.

At step (2), 1 g of gelatin was added to 1 g of ethyl acetate to obtain an oil phase I.

At step (3), the saline solution was added to the oil phase I, followed by homogenizing and shearing at 1000 rpm for 30 min to form a uniform W/O emulsion.

At step (4), the emulsion obtained in step (3) was added to 35 g of glycerol, followed by stirring to form a microcapsule-containing multiple emulsion.

At step (5), the microcapsule-containing multiple emulsion obtained in step (4) was subject to magnetic stirring at 200 rmp for 1 h, followed by curing to obtain a final microcapsule.

### Example 20

At step (1), 6 g of potassium chloride was dissolved in 114 g of deionized water to obtain a saline solution.

At step (2), 4 g of fibrous protein was added to 396 g of heptane to obtain an oil phase I.

At step (3), the saline solution was added to the oil phase I, followed by homogenizing and shearing at 8000 rpm for 5 min to form a uniform W/O emulsion.

At step (4), the emulsion obtained in step (3) was added to 260 g of ethanol, followed by stirring to form a microcapsule-containing multiple emulsion.

At step (5), the microcapsule-containing multiple emulsion obtained in step (4) was subject to magnetic stirring at 200 rmp for 1 h, followed by curing to obtain a final microcapsule.

### Example 21

At step (1), 9 g of potassium acetate was dissolved in 100 g of deionized water to obtain a saline solution.

At step (2), 1 g of polyvinyl alcohol was added to 40 g of acetonitrile to obtain an oil phase I.

At step (3), the saline solution was added to the oil phase I, followed by homogenizing and shearing at 5000 rpm for 10 min to form a uniform W/O emulsion.

At step (4), the emulsion obtained in step (3) was added to 60 g of propylene glycol, followed by stirring to form a microcapsule-containing multiple emulsion.

At step (5), the microcapsule-containing multiple emulsion obtained in step (4) was subject to magnetic stirring at 200 rmp for 1 h, followed by curing to obtain a final microcapsule.

### Example 22

At step (1), 9 g of potassium acetate was dissolved in 100 g of deionized water to obtain a saline solution.

At step (2), 1 g of polylactic acid-polyhydroxyacetic acid was added to 50 g of acetone to obtain an oil phase I.

At step (3), the saline solution was added to the oil phase I, followed by homogenizing and shearing at 6000 rpm for 10 min to form a uniform W/O emulsion.

At step (4), the emulsion obtained in step (3) was added to 70 g of ethylene glycol, followed by stirring to form a microcapsule-containing multiple emulsion.

At step (5), the microcapsule-containing multiple emulsion obtained in step (4) was subject to magnetic stirring at 200 rmp for 1 h, followed by curing to obtain a final microcapsule.

### Example 23

At step (1), 9 g of potassium acetate was dissolved in 100 g of deionized water to obtain a saline solution.

At step (2), 1 g of polycarbonate was added to 40 g of chloroform to obtain an oil phase I.

At step (3), the saline solution was added to the oil phase I, followed by homogenizing and shearing at 6000 rpm for 10 min to form a uniform W/O emulsion.

At step (4), the emulsion obtained in step (3) was added to 60 g of dimeticone, followed by stirring to form a microcapsule-containing multiple emulsion.

At step (5), the microcapsule-containing multiple emulsion obtained in step (4) was subject to magnetic stirring at 200 rmp for 1 h, followed by curing to obtain a final microcapsule.

### Example 24

At step (1), 9.5 g of sodium chloride and 0.1579 g of ethylenediamine were added to 50 g of water at the same time to fully dissolve, followed by adjusting a pH value to 10.5 using sodium hydroxide to form an aqueous phase.

At step (2), 1 g of sodium dodecylbenzene sulfonate was added to 100 mL of chloroform, followed by stirring to form an oil phase I.

At step (3), the aqueous phase obtained in step (1) was slowly added to the oil phase I obtained in step (2), followed by homogenizing and shearing at 5000 rpm for 10 min to obtain a stable W/O emulsion.

At step (4), 0.5342 g of terephthaloyl chloride was weighted to dissolve in 50 mL of chloroform to obtain an oil phase II; the oil phase II was added dropwise to the W/O emulsion slowly by a peristaltic pump; and a polymerization reaction was carried out for 20 min to obtain a microcapsule-containing suspension.

At step (5), the suspension was filtered and washed 3-5 times with deionized water before being dried in a drying oven at 60° C. for 24 h to obtain salt-storage microcapsule powder.

### Example 25

At step (1), 9 g of sodium chloride and 0.3158 g of ethylenediamine were added to 50 g of water at the same time to fully dissolve, followed by adjusting a pH value to 10.5 using sodium hydroxide to form an aqueous phase.

At step (2), 1 g of sodium dodecylbenzene sulfonate was added to 100 mL of chloroform, followed by stirring to form an oil phase I.

At step (3), the aqueous phase obtained in step (1) was slowly added to the oil phase I obtained in step (2), followed by homogenizing and shearing at 5000 rpm for 10 min to obtain a stable W/O emulsion.

At step (4), 1.0684 g of terephthaloyl chloride was weighted to dissolve in 50 mL of chloroform to obtain an oil phase II; the oil phase II was added dropwise to the W/O emulsion slowly by a peristaltic pump; and a polymerization reaction was carried out for 20 min to obtain a microcapsule-containing suspension.

At step (5), the suspension was filtered and washed 3-5 times with deionized water before being dried in a drying oven at 60° C. for 24 h to obtain salt-storage microcapsule powder.

### Example 26

At step (1), 8 g of sodium chloride and 0.6316 g of ethylenediamine were added to 50 g of water at the same time to fully dissolve, followed by adjusting a pH value to 10.5 using sodium hydroxide to form an aqueous phase.

At step (2), 1 g of sodium dodecylbenzene sulfonate was added to 100 mL of chloroform, followed by stirring to form an oil phase I.

At step (3), the aqueous phase obtained in step (1) was slowly added to the oil phase I obtained in step (2), followed by homogenizing and shearing at 5000 rpm for 10 min to obtain a stable W/O emulsion.

At step (4), 2.1368 g of terephthaloyl chloride was weighted to dissolve in 50 mL of chloroform to obtain an oil phase II; the oil phase II was added dropwise to the W/O emulsion slowly by a peristaltic pump; and a polymerization reaction was carried out for 20 min to obtain a microcapsule-containing suspension.

At step (5), the suspension was filtered and washed 3-5 times with deionized water before being dried in a drying oven at 60° C. for 24 h to obtain salt-storage microcapsule powder.

### Example 27

At step (1), 6 g of sodium chloride and 1.2632 g of ethylenediamine were added to 50 g of water at the same time to fully dissolve, followed by adjusting a pH value to 10.5 using sodium hydroxide to form an aqueous phase.

At step (2), 1 g of sodium dodecylbenzene sulfonate was added to 100 mL of chloroform, followed by stirring to form an oil phase I.

At step (3), the aqueous phase obtained in step (1) was slowly added to the oil phase I obtained in step (2), followed by homogenizing and shearing at 5000 rpm for 10 min to obtain a stable W/O emulsion.

At step (4), 4.2737 g of terephthaloyl chloride was weighted to dissolve in 50 mL of chloroform to obtain an oil phase II; the oil phase II was added dropwise to the W/O emulsion slowly by a peristaltic pump; and a polymerization reaction was carried out for 20 min to obtain a microcapsule-containing suspension.

At step (5), the suspension was filtered and washed 3-5 times with deionized water before being dried in a drying oven at 60° C. for 24 h to obtain salt-storage microcapsule powder.

### Example 28

At step (1), 8 g of sodium chloride and 0.7453 g of ethylenediamine were added to 50 g of water at the same time to fully dissolve, followed by adjusting a pH value to 10.5 using sodium hydroxide to form an aqueous phase.

At step (2), 1 g of sodium dodecylbenzene sulfonate was added to 100 mL of chloroform, followed by stirring to form an oil phase I.

At step (3), the aqueous phase obtained in step (1) was slowly added to the oil phase I obtained in step (2), followed by homogenizing and shearing at 5000 rpm for 10 min to obtain a stable W/O emulsion.

At step (4), 2.1615 g of toluene diisocyanate was weighted to dissolve in 50 mL of chloroform to obtain an oil phase II; the oil phase II was added dropwise to the W/O emulsion slowly by a peristaltic pump; and a polymerization reaction was carried out for 20 min to obtain a microcapsule-containing suspension.

At step (5), the suspension was filtered and washed 3-5 times with deionized water before being dried in a drying oven at 60° C. for 24 h to obtain salt-storage microcapsule powder.

### Example 29

At step (1), 8 g of sodium chloride and 0.7059 g of ethylenediamine were added to 50 g of water at the same time to fully dissolve, followed by adjusting a pH value to 10.5 using sodium hydroxide to form an aqueous phase.

At step (2), 1 g of sodium dodecylbenzene sulfonate was added to 100 mL of chloroform, followed by stirring to form an oil phase I.

At step (3), the aqueous phase obtained in step (1) was slowly added to the oil phase I obtained in step (2), followed by homogenizing and shearing at 5000 rpm for 10 min to obtain a stable W/O emulsion.

At step (4), 2.1529 g of adipoyl chloride was weighted to dissolve in 50 mL of chloroform to obtain an oil phase II; the oil phase II was added dropwise to the W/O emulsion slowly by a peristaltic pump; and a polymerization reaction was carried out for 20 min to obtain a microcapsule-containing suspension.

At step (5), the suspension was filtered and washed 3-5 times with deionized water before being dried in a drying oven at 60° C. for 24 h to obtain salt-storage microcapsule powder.

### Example 30

At step (1), 9 g of potassium acetate and 0.3803 g of ethylene glycol were added to 27 g of water at the same time to fully dissolve, followed by adjusting a pH value to 10 using sodium bicarbonate to form an aqueous phase.

At step (2), 1.35 g of sodium alginate was added to 67.5 mL of toluene, followed by stirring to form an oil phase I.

At step (3), the aqueous phase obtained in step (1) was slowly added to the oil phase I obtained in step (2), followed by homogenizing and shearing at 8000 rpm for 5 min to obtain a stable W/O emulsion.

At step (4), 1.0675 g of toluene diisocyanate was weighted to dissolve in 67.5 mL of toluene to obtain an oil phase II; the oil phase II was added dropwise to the W/O emulsion slowly by a peristaltic pump; and a polymerization reaction was carried out for 20 min to obtain a microcapsule-containing suspension.

At step (5), the suspension was filtered and washed 3-5 times with deionized water before being dried in a drying oven at 60° C. for 24 h to obtain salt-storage microcapsule powder.

### Example 31

At step (1), 6 g of magnesium chloride and 1.2917 g of ethylenediphenol were added to 114 g of water at the same time to fully dissolve, followed by adjusting a pH value to 11 using sodium carbonate to form an aqueous phase.

At step (2), 5.13 g of sorbitol was added to 171 mL of dichloromethane, followed by stirring to form an oil phase I.

At step (3), the aqueous phase obtained in step (1) was slowly added to the oil phase I obtained in step (2), followed by homogenizing and shearing at 1000 rpm for 30 min to obtain a stable W/O emulsion.

At step (4), 4.2292 g of terephthaloyl chloride was weighted to dissolve in 57 mL of dichloromethane to obtain an oil phase II; the oil phase II was added dropwise to the W/O emulsion slowly by a peristaltic pump; and a polymerization reaction was carried out for 20 min to obtain a microcapsule-containing suspension.

At step (5), the suspension was filtered and washed 3-5 times with deionized water before being dried in a drying oven at 60° C. for 24 h to obtain salt-storage microcapsule powder.

### Example 32

At step (1), 8 g of calcium chloride and 0.7059 g of ethylenediamine were added to 50 g of water at the same time to fully dissolve, followed by adjusting a pH value to 10.5 using potassium carbonate to form an aqueous phase.

At step (2), 1 g of span 20 was added to 100 mL of cyclohexane, followed by stirring to form an oil phase I.

At step (3), the aqueous phase obtained in step (1) was slowly added to the oil phase I obtained in step (2), followed by homogenizing and shearing at 5000 rpm for 20 min to obtain a stable W/O emulsion.

At step (4), 2.1529 g of adipoyl chloride was weighted to dissolve in 50 mL of cyclohexane to obtain an oil phase II; the oil phase II was added dropwise to the W/O emulsion slowly by a peristaltic pump; and a polymerization reaction was carried out for 20 min to obtain a microcapsule-containing suspension.

At step (5), the suspension was filtered and washed 3-5 times with deionized water before being dried in a drying oven at 60° C. for 24 h to obtain salt-storage microcapsule powder.

Span 20 can also be replaced with span 40, span 60, or span 80.

### Example 33

At step (1), 9 g of potassium chloride and 0.3229 g of ethylenediphenol were added to 50 g of water at the same time to fully dissolve, followed by adjusting a pH value to 10.5 using potassium hydroxide to form an aqueous phase.

At step (2), 1 g of tween 20 was added to 100 mL of carbon tetrachloride, followed by stirring to form an oil phase I.

At step (3), the aqueous phase obtained in step (1) was slowly added to the oil phase I obtained in step (2), followed by homogenizing and shearing at 5000 rpm for 10 min to obtain a stable W/O emulsion.

At step (4), 1.0573 g of terephthaloyl chloride was weighted to dissolve in 50 mL of carbon tetrachloride to obtain an oil phase II; the oil phase II was added dropwise to the W/O emulsion slowly by a peristaltic pump; and a polymerization reaction was carried out for 20 min to obtain a microcapsule-containing suspension.

At step (5), the suspension was filtered and washed 3-5 times with deionized water before being dried in a drying oven at 60° C. for 24 h to obtain salt-storage microcapsule powder.

Tween 20 can also be replaced with tween 40, tween 60, or tween 80.

### Comparative Example 1

16 g of sodium chloride was completely dissolved in 200 mL of deionized water, and 4 g of carrier was added, followed by stirring at a constant temperature of 70° C. until a paste was formed. The paste was dried in a drying oven at 60° C. before being pulverized in a universal pulverizer until a sieve pore of 0.075 mm could be passed through, and a carrier material of sodium chloride prepared by wet preparation was obtained.

The performance of the slow-release salt-storage snow-melting and ice-suppressing microcapsule prepared in the present disclosure is analyzed below.

(1) A test for analyzing dissolution of the slow-release salt-storage snow-melting and ice-suppressing microcapsules prepared in Examples 1-4

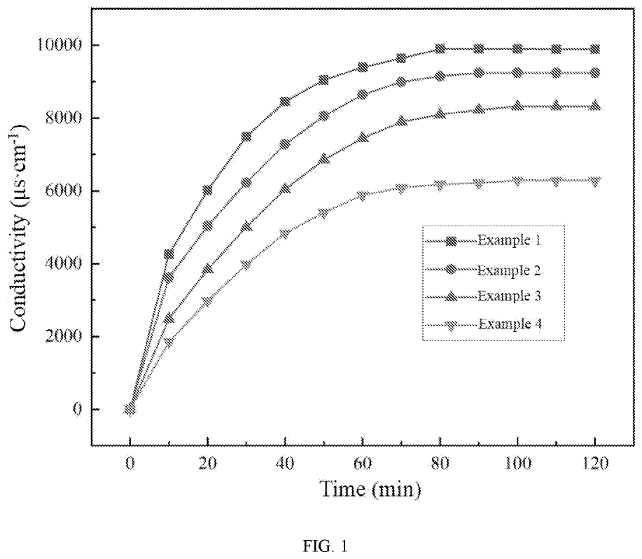

150 mL of deionized water and 1 g of material were added to a dissolution cup, followed by stirring at a low rotating speed of 100 r/min, with a temperature of a dissolution apparatus being set to 25° C., and conductivity changes in a solution were continuously measured by a conductivity meter. Generally, the more ions contained in the solution, the better the ability to transfer electrons and the greater the conductivity value, that is, a higher conductivity means more snow-melt salt precipitates into the solution. The results are shown in FIG. 1.

Referring to FIG. 1, as can be seen from Examples 1-4, as a wall-to-core material ratio of the snow-melting and ice-suppressing microcapsule increases from 5% to 40%, the conductivity when the salt is completely dissolved out decreases from 9890 μs·cm−1 to 6284 μs·cm−1, indicating that the smaller the salt content in the snow-melting and ice-suppressing microcapsule is, the lower the conductivity is when the salt is completely dissolved out, and accordingly, the weaker the snow-melting and ice-suppressing ability is. No further change in conductivity indicates complete dissolution of salt from the material. As the wall-to-core material ratio increases from 5% to 20%, a dissolution time increases from 80 min to 100 min, and as the wall material increases from 20% to 40%, the dissolution time remains unchanged at 100 min, indicating that both wall material and core material contents affect the dissolution time, and that the longer the dissolution time, the longer the slow-release time and the stronger the slow-release ability. In conclusion, the material with a wall-to-core ratio of 20% in Example 3 has better performance and better meets the snow and ice melting needs of pavements.

(2) A test for analyzing water permeability of the slow-release salt-storage snow-melting and ice-suppressing microcapsules in the examples and of some existing snow-melting and ice-suppressing materials

At 25° C., several small holes were poked in the bottom of a transparent disposable plastic cup; 20 g of samples were spread out and compacted at the bottom of the cup; 100 mL of deionized water was slowly poured into along a wall of the cup to observe permeation time and flow-completion time. Chlorine ions of a filtration liquid or supernatant were measured by a chlorine ion meter. Generally, the longer the permeation time and flow-completion time, the stronger the hydrophobic and slow-release abilities of the material. Test results are shown in Table 1.

TABLE 1
Water permeability of different materials

| | | | | | Sodium chloride |
|---|---|---|---|---|---|
| | Permeation | | Flow-completion | | concentration |
| Types of material | time | | time | | (mol · L − 1) |
| Sodium chloride | 5 | s | 15 | s | 1.15 |
| Comparative | 40 | s | 5 | h | 0.946 |
| Example 1 | | | | | |
| Mafilon | 48 | h | 5 | d | 0.299 |
| Example 3 | 60 | h | 8 | d | 0.234 |
| Example 5 | 62 | h | 8 | d | 0.221 |
| Example 6 | 58 | h | 8 | d | 0.239 |
| Example 7 | 60 | h | 8 | d | 0.236 |
| Example 14 | 50 | h | 6.5 | d | 0.258 |
| Example 16 | 55 | h | 7 | d | 0.237 |
| Example 17 | 54 | h | 7 | d | 0.239 |
| Example 18 | 52 | h | 7 | d | 0.248 |
| Example 26 | 65 | h | 9 | d | 0.187 |
| Example 28 | 65 | h | 9 | d | 0.192 |
| Example 29 | 64 | h | 9 | d | 0.198 |

As can be seen from the results of the water permeability in Table 1, the permeation time and flow-completion time for pure sodium chloride are 5 s and 15 s, respectively, compared with 40 s and 5 h for the material prepared by wet adsorption in Comparative Example 1, and 48 h and 5 d for Mafilon, an effective snow-melting and ice-suppressing agent currently available on the market. Both the permeation time and flow-completion time for sodium chloride encapsulated by wall material increase over Mafilon, indicating that it is more difficult for water to pass through the wall material of the microcapsule, and the slow-release time is greatly improved, and the slow-release performance is significantly enhanced. Example 3 and Example 16 employ the same wall material, but different preparation methods. The permeation time and flow-completion time for the material prepared by spray drying method in Example 3 are 60 h and 8 d, respectively, compared with 55 h and 7 d for the material prepared by phase separation method in Example 16, showing a longer permeation time and flow-completion time for the material prepared in Example 1, and indicating that the microcapsule prepared by spray drying method has better quality and the wall material can encapsulate the core material better. In addition, the permeation time and flow-completion time for the materials prepared by interfacial polymerization method in Example 26, Example 28, and Example 29 are 65 h and 9 d, 65 h and 9 d, and 64 h and 9 d, respectively, showing a longer dissolution time and flow-completion time for the snow-melting and ice-suppressing microcapsule prepared by interfacial polymerization method than the microcapsules prepared by other two methods, with a relatively low concentration of sodium chloride, indicating that the wall material of the microcapsule prepared by the method has stronger hydrophobic and slow-release abilities.

(3) A test for analyzing freezing points of the slow-release salt storage snow-melting and ice-suppressing microcapsules in the examples and of some existing snow-melting and ice-suppressing materials

10 mL of deionized water was added to three test tubes separately, 2 g of samples was added to the water separately, and the test tubes were put into a low-temperature constant-temperature reaction bath, followed by continuously cooling down. A temperature gauge was used to measure freezing points of solutions. Generally, the lower the freezing point, the stronger the ice-melting and ice-suppressing ability. The test results are shown in Table 2.

TABLE 2
Freezing points of different materials

| | Freezing | | Freezing |
|---|---|---|---|
| Types of material | point/° C. | Types of material | point/° C. |
| Deionized water | 0 | Comparative | −2.37 |
| | | Example 1 | |
| Mafilon | −5.43 | Example 3 | −7.34 |
| Example 5 | −7.85 | Example 6 | −7.08 |
| Example 7 | −7.40 | Example 14 | −5.87 |
| Example 16 | −6.14 | Example 17 | −6.20 |
| Example 18 | −5.98 | Example 26 | −7.46 |
| Example 28 | −7.43 | Example 29 | −7.38 |

As can be seen from Table 2, the freezing points of the materials prepared by spray drying method in Example 3, Example 5, Example 6, and Example 7 are −7.34° C., −7.85° C., −7.08° C., and −7.40° C., respectively, compared with −5.87° C., −6.14° C., −6.20° C., and −5.98° C. of the materials prepared by phase separation method in Example 14, Example 16, Example 17, and Example 18, and −7.46° C., −7.43° C., and −7.38° C. of the materials prepared by interfacial polymerization method in Examples 26, Example 28, and Example 29. The freezing points of the materials prepared in Example 3 and Example 16 are −7.31° C. and −6.14° C., showing that the material prepared with gelatin as a wall material in Example 3 has a lower freezing point and stronger snow-melting and ice-suppressing ability, and that the wall material of the microcapsule prepared by spray drying method can encapsulate the core material better than that prepared by phase separation method. All the freezing points of the snow-melting and ice-suppressing microcapsules prepared in the above examples are lower in comparison to those of Comparative Example 1 and Mafilon, indicating that the snow-melting and ice-suppressing microcapsule prepared by the present disclosure has a stronger ability to lower the freezing point and more effectively inhibits the freezing of accumulated snow on pavements.

(4) A test for analyzing dissolution of the slow-release salt-storage snow-melting and ice-suppressing microcapsules in the examples and of some existing snow-melting and ice-suppressing materials

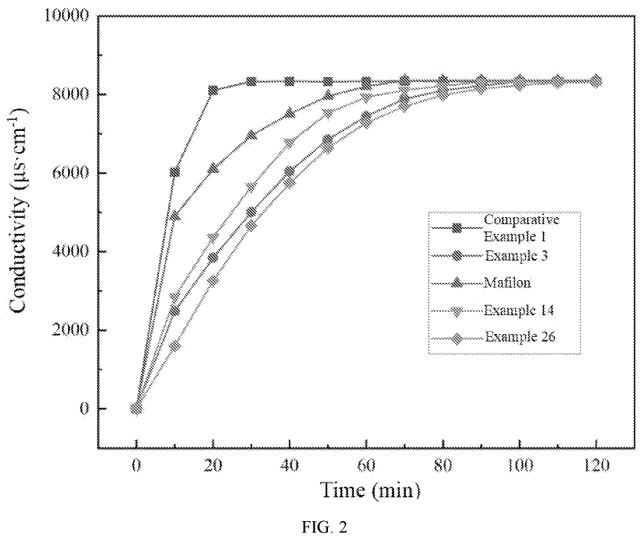

150 mL of deionized water and 1 g of material were added to a dissolution cup, followed by stirring at a low rotating speed of 100 r/min, with a temperature of a dissolution apparatus being set to 25° C., and conductivity changes in a solution were continuously measured by a conductivity meter. Generally, the more ions contained in the solution, the better the ability to transfer electrons and the greater the conductivity value, that is, a higher conductivity means more snow-melt salt precipitates into the solution. The results are shown in FIG. 2.

As can be seen from FIG. 2, the conductivities of sodium chloride in Example 3, Example 14, Example 26, Mafilon, and Comparative Example 1 are 8300 μS/cm−1, 8329 μS/cm−1, 8312 μS/cm−1, 8357 μS/cm−1, and 8339 μS/cm−1 when the salt is completely dissolved out. The essentially same conductivity indicates that salt contents of the materials are essentially the same, and no further change in conductivity indicates that the salt in the material is completely dissolved out. The dissolution time for the material prepared by interfacial polymerization method in Example 26 is 120 min, the longest, indicating the strongest slow-release ability. The dissolution time for the material prepared by spray drying method in Example 3 is 100 min, the dissolution time for the material prepared by phase separation method in Example 14 is 90 min, the dissolution time in Comparative Example 1 is 30 min, and the dissolution time for Mafilon material is 70 min, which can be seen that the snow-melting and ice-suppressing microcapsules prepared by the three methods have a longer dissolution time than that of both the material prepared by wet adsorption in Comparative Example 1 and the Mafilon material, indicating that a dissolution and diffusion rate of sodium chloride in aqueous solution of the snow-melting and ice-suppressing microcapsule prepared by the present disclosure is lower, the slow-release effect is better, and the snow-melting and ice-suppressing ability will be stronger in pavements.

Although preferred examples of the present disclosure have been described, those examples can be subject to additional changes and modifications once the basic creative concepts are known to those skilled in the art. Accordingly, the attached claims are intended to be interpreted to include the preferred examples as well as all variations and modifications falling within the scope of the present disclosure.

It will be apparent that those skilled in the art may make various variations and modifications to the present disclosure without departing from the spirit and scope of the present disclosure. Therefore, the present disclosure is also intended to include such modifications and variations provided that they fall within the scope of the claims of the present disclosure and equivalents thereof.

1. A slow-release salt-storage snow-melting and ice-suppressing microcapsule, prepared using a high polymer material as a wall material and salt as a core material.

2. The slow-release salt-storage snow-melting and ice-suppressing microcapsule according to claim 1, wherein the salt is one of potassium acetate, sodium chloride, calcium chloride, magnesium chloride and potassium chloride; and
the high polymer material is one of gum arabic, gelatin, polyvinyl alcohol, agar, amylose, polylactic acid, fibrous protein, polylactic acid-polyhydroxyacetic acid, and polycarbonate.

3. A preparation method for a slow-release salt-storage snow-melting and ice-suppressing microcapsule according to claim 1, comprising the following steps of:
dissolving salt in water, and encapsulating the salt with a wall material to obtain a slow-release salt-storage snow-melting and ice-suppressing microcapsule using a spray drying method, a phase separation method or an interfacial polymerization method.

4. A preparation method for a slow-release salt-storage snow-melting and ice-suppressing microcapsule according to claim 2, comprising the following steps of:
dissolving salt in water, and encapsulating the salt with a wall material to obtain a slow-release salt-storage snow-melting and ice-suppressing microcapsule using a spray drying method, a phase separation method or an interfacial polymerization method.

5. The preparation method for a slow-release salt-storage snow-melting and ice-suppressing microcapsule according to claim 3, wherein a slow-release salt-storage snow-melting and ice-suppressing microcapsule is prepared using the spray drying method, comprising the following steps of:
dissolving salt in water to obtain a solution A; dissolving a wall material in water, followed by heating and stirring at 90-97° C. to obtain a solution B; and performing homogeneous dispersion of the solution B and the solution A before performing uniform mixing, performing dilution until a solid content is 10%-20% to obtain a solution C, and performing spray-drying of the solution C to obtain the slow-release salt-storage snow-melting and ice-suppressing microcapsule.

6. The preparation method for a slow-release salt-storage snow-melting and ice-suppressing microcapsule according to claim 4, wherein a slow-release salt-storage snow-melting and ice-suppressing microcapsule is prepared using the spray drying method, comprising the following steps of:
dissolving salt in water to obtain a solution A; dissolving a wall material in water, followed by heating and stirring at 90-97° C. to obtain a solution B; and performing homogeneous dispersion of the solution B and the solution A before performing uniform mixing, performing dilution until a solid content is 10%-20% to obtain a solution C, and performing spray-drying of the solution C to obtain the slow-release salt-storage snow-melting and ice-suppressing microcapsule.

7. The preparation method for a slow-release salt-storage snow-melting and ice-suppressing microcapsule according to claim 5, wherein the wall material accounts for 5%-40% of a total mass of the salt and the wall material, a rotating speed of the homogeneous dispersion is 8000-12000 rpm, and a time of the homogeneous dispersion is 5-15 min;
the wall material is one of gum arabic, gelatin, polyvinyl alcohol, agar, and amylose; and
conditions of the spray-drying are: an inlet temperature of 180-220° C., an outlet temperature of 80-115° C., an inlet air volume of 75-90 m3/h, a feed rate of 10-20 mL/min, and a pressure pump of 0.15-0.3 MPa.

8. The preparation method for a slow-release salt-storage snow-melting and ice-suppressing microcapsule according to claim 6, wherein the wall material accounts for 5%-40% of a total mass of the salt and the wall material, a rotating speed of the homogeneous dispersion is 8000-12000 rpm, and a time of the homogeneous dispersion is 5-15 min;
the wall material is one of gum arabic, gelatin, polyvinyl alcohol, agar, and amylose; and
conditions of the spray-drying are: an inlet temperature of 180-220° C., an outlet temperature of 80-115° C., an inlet air volume of 75-90 m3/h, a feed rate of 10-20 mL/min, and a pressure pump of 0.15-0.3 MPa.

9. The preparation method for a slow-release salt-storage snow-melting and ice-suppressing microcapsule according to claim 3, wherein a slow-release salt-storage snow-melting and ice-suppressing microcapsule is prepared using the phase separation method, comprising the following steps of:
dissolving salt in water, followed by stirring uniformly to obtain a solution A; and dissolving a wall material in an organic solvent A, followed by stirring to obtain a solution B; and
mixing the solution B and the solution A before performing uniform homogeneous dispersion to obtain a solution D, adding the solution D to an organic solvent B, followed by stirring to obtain a microcapsule-containing multiple emulsion; and stirring the microcapsule-containing multiple emulsion before performing curing to obtain the slow-release salt-storage snow-melting and ice-suppressing microcapsule.

10. The preparation method for a slow-release salt-storage snow-melting and ice-suppressing microcapsule according to claim 4, wherein a slow-release salt-storage snow-melting and ice-suppressing microcapsule is prepared using the phase separation method, comprising the following steps of:
dissolving salt in water, followed by stirring uniformly to obtain a solution A; and dissolving a wall material in an organic solvent A, followed by stirring to obtain a solution B; and
mixing the solution B and the solution A before performing uniform homogeneous dispersion to obtain a solution D, adding the solution D to an organic solvent B, followed by stirring to obtain a microcapsule-containing multiple emulsion; and stirring the microcapsule-containing multiple emulsion before performing curing to obtain the slow-release salt-storage snow-melting and ice-suppressing microcapsule.

11. The preparation method for a slow-release salt-storage snow-melting and ice-suppressing microcapsule according to claim 9, wherein a mass ratio of the salt to the water is 1:3-19; the wall material accounts for 5%-40% of a total mass of the salt and the wall material; and a mass ratio of the wall material to the organic solvent A is 1:1-99;
a rotating speed of the homogeneous dispersion is 1000-8000 rpm, and a time of the homogeneous dispersion is 5-30 min;
a mass ratio of the organic solvent B to the solution D is 1:1-2.5;
the wall material is one of polylactic acid, gelatin, fibrous protein, polyvinyl alcohol, polylactic acid-polyhydroxyacetic acid, and polycarbonate;
the organic solvent A is one of dichloromethane, ethyl acetate, acetonitrile, heptane, chloroform or acetone; and
the organic solvent B is one of glycerol, ethanol, propylene glycol, ethylene glycol or dimeticone.

12. The preparation method for a slow-release salt-storage snow-melting and ice-suppressing microcapsule according to claim 10, wherein a mass ratio of the salt to the water is 1:3-19; the wall material accounts for 5%-40% of a total mass of the salt and the wall material; and a mass ratio of the wall material to the organic solvent A is 1:1-99;
a rotating speed of the homogeneous dispersion is 1000-8000 rpm, and a time of the homogeneous dispersion is 5-30 min;
a mass ratio of the organic solvent B to the solution D is 1:1-2.5;
the wall material is one of polylactic acid, gelatin, fibrous protein, polyvinyl alcohol, polylactic acid-polyhydroxyacetic acid, and polycarbonate;
the organic solvent A is one of dichloromethane, ethyl acetate, acetonitrile, heptane, chloroform or acetone; and
the organic solvent B is one of glycerol, ethanol, propylene glycol, ethylene glycol or dimeticone.

13. The preparation method for a slow-release salt-storage snow-melting and ice-suppressing microcapsule according to claim 3, wherein a slow-release salt-storage snow-melting and ice-suppressing microcapsule is prepared using the interfacial polymerization method, comprising the following steps of:
dissolving salt and a monomer A in water, followed by stirring uniformly to obtain a solution A, and adjusting a pH value of the solution A to 10-11 to obtain an aqueous phase solution;
adding an emulsifier to an organic solvent C to obtain an oil phase solution;
performing uniform homogeneous dispersion of the aqueous phase solution and the oil phase solution to obtain an emulsion; and
dissolving a monomer D in an organic solvent D to obtain a solution E, adding the solution E to the emulsion, followed by stirring uniformly and reacting to obtain a final solution F, and filtering, washing and drying the solution F in sequence to obtain the slow-release salt-storage snow-melting and ice-suppressing microcapsule.

14. The preparation method for a slow-release salt-storage snow-melting and ice-suppressing microcapsule according to claim 4, wherein a slow-release salt-storage snow-melting and ice-suppressing microcapsule is prepared using the interfacial polymerization method, comprising the following steps of:
dissolving salt and a monomer A in water, followed by stirring uniformly to obtain a solution A, and adjusting a pH value of the solution A to 10-11 to obtain an aqueous phase solution;
adding an emulsifier to an organic solvent C to obtain an oil phase solution;
performing uniform homogeneous dispersion of the aqueous phase solution and the oil phase solution to obtain an emulsion; and
dissolving a monomer D in an organic solvent D to obtain a solution E, adding the solution E to the emulsion, followed by stirring uniformly and reacting to obtain a final solution F, and filtering, washing and drying the solution F in sequence to obtain the slow-release salt-storage snow-melting and ice-suppressing microcapsule.

15. The preparation method for a slow-release salt-storage snow-melting and ice-suppressing microcapsule according to claim 13, wherein a mass ratio of the salt to the water is 1:3-19;
a ratio of the emulsifier to the organic solvent C is 1-3 g:100 ml, the emulsifier being one of sodium dodecylbenzene sulfonate, sodium alginate, sorbitol, styrene-maleic anhydride, span 20, span 40, span 60, span 80, tween 20, tween 40, tween 60, and tween 80;
a volume ratio of the organic solvent C and the organic solvent D to the water is 2-5:1, and a volume ratio of the organic solvent C to the organic solvent D is 1-3:1, both the organic solvent C and the organic solvent D being one of cyclohexane, dichloromethane, carbon tetrachloride, toluene, and chloroform;
a sum of the monomer A and the monomer D accounts for 5%-40% of a total mass of the salt, the monomer A and the monomer D, and a molar ratio of the monomer A to the monomer D is 1:1, the monomer A being one of ethylenediamine, ethylene glycol, and ethylenediphenol, and the monomer D being one of terephthaloyl chloride, toluene diisocyanate, and adipoyl chloride; and
a rotating speed of the homogeneous dispersion is 1000-8000 rpm, and a time of the homogeneous dispersion is 5-30 min.

16. The preparation method for a slow-release salt-storage snow-melting and ice-suppressing microcapsule according to claim 14, wherein a mass ratio of the salt to the water is 1:3-19;
a ratio of the emulsifier to the organic solvent C is 1-3 g:100 ml, the emulsifier being one of sodium dodecylbenzene sulfonate, sodium alginate, sorbitol, styrene-maleic anhydride, span 20, span 40, span 60, span 80, tween 20, tween 40, tween 60, and tween 80;
a volume ratio of the organic solvent C and the organic solvent D to the water is 2-5:1, and a volume ratio of the organic solvent C to the organic solvent D is 1-3:1, both the organic solvent C and the organic solvent D being one of cyclohexane, dichloromethane, carbon tetrachloride, toluene, and chloroform;
a sum of the monomer A and the monomer D accounts for 5%-40% of a total mass of the salt, the monomer A and the monomer D, and a molar ratio of the monomer A to the monomer D is 1:1, the monomer A being one of ethylenediamine, ethylene glycol, and ethylenediphenol, and the monomer D being one of terephthaloyl chloride, toluene diisocyanate, and adipoyl chloride; and
a rotating speed of the homogeneous dispersion is 1000-8000 rpm, and a time of the homogeneous dispersion is 5-30 min.

17. The preparation method for a slow-release salt-storage snow-melting and ice-suppressing microcapsule according to claim 13, wherein a pH modifier is employed to adjust the pH value, the pH modifier being one of sodium hydroxide, potassium hydroxide, sodium bicarbonate, sodium carbonate, potassium carbonate.

18. The preparation method for a slow-release salt-storage snow-melting and ice-suppressing microcapsule according to claim 14, wherein a pH modifier is employed to adjust the pH value, the pH modifier being one of sodium hydroxide, potassium hydroxide, sodium bicarbonate, sodium carbonate, potassium carbonate.
